(19) United States
(12) Patent Application Publication
(10) Pub. No.: US 2024/0123839 A1
(43) Pub. Date: Apr. 18, 2024

(54) Secondary Bicycle Drive Battery and Method

(71) Applicant: VANMOOF B.V., Amsterdam (NL)

(72) Inventors: Ties Jonan Midas Carlier, Amsterdam (NL); Jean-Paul Niellissen, Amsterdam (NL)

(21) Appl. No.: 18/277,840

(22) PCT Filed: Feb. 22, 2022
(86) PCT No.: PCT/NL2022/050091

§ 371 Date: Aug. 18, 2023

(30) Foreign Application Priority Data
Feb. 22, 2021 (NL) 2027611
Apr. 6, 2021 (NL) 2027925

(51) Int. Cl. B60L 50/60; B60L 50/20; B60L 50/64; B60L 53/62; H01M 50/244; H02J 7/00; H02J 7/34

(52) U.S. Cl. CPC B60L 50/66; B60L 50/20; B60L 50/64; B60L 53/62; H01M 50/244; H02J 7/00036; H02J 7/0024; H02J 7/00711; H02J 7/342; B60L 2200/12; H01M 2220/20; H02J 2207/40

(57) ABSTRACT

Provided is a secondary bicycle drive battery for a bicycle as secondary, preferably external, energy source in addition to a primary bicycle drive battery as primary, preferably internal, drive energy source of the bicycle, for there with driving of a drive motor, the secondary bicycle drive battery including a housing, fastening means that are connected or connectable with the housing for fastening of the housing to the bicycle, such as a frame thereof, a predetermined number of battery cells, a control unit, such as a BMS, such as for controlling of charging and discharging of the battery cells, a voltage regulation circuit, such as a voltage stabilization circuit or a boost circuit, for controlling of a voltage of a secondary output current to a predetermined value for providing of an input current, such as via a charge connector, for the bicycle, a charge current connection, such as including a current output connector or a charge cable, for providing of the secondary output current to the bicycle, such as to the charge connector thereof, and a communication unit for communication of a signal for the purpose of communicating of status information with regards to the secondary battery to the bicycle, such as to a BMS, communication unit and/or onboard computer thereof.

### CROSS REFERENCE TO RELATED APPLICATIONS

This application is the United States national phase of International Patent Application No. PCT/NL2022/050091 filed Feb. 22, 2022, and claims priority to The Netherlands Patent Application Nos. 2027611 filed Feb. 22, 2021 and U.S. Pat. No. 2,027,925 filed Apr. 6, 2021, the disclosures of which are hereby incorporated by reference in their entireties.

### BACKGROUND OF THE INVENTION

### Field of the Invention

The present invention relates to a secondary bicycle drive battery for a bicycle as a secondary, preferably external, energy source in addition to a primary bicycle drive battery as the primary, preferably internal, drive energy source of the bicycle for thereby driving a drive motor and/or charging an on-board computer battery by the secondary bicycle drive battery. Furthermore, the present invention relates to a bicycle adapted for cooperation with the secondary bicycle drive battery. Further, the present invention relates to a method of operating a secondary bicycle drive battery for a bicycle as a secondary, preferably external, energy source in addition to a primary bicycle drive battery as the primary, preferably internal, bicycle drive power source of the bicycle for driving a drive motor therewith. Furthermore, the present invention relates to a driving method for a bicycle having a primary bicycle drive battery and a secondary bicycle drive battery for taking up power from the combination of primary driving battery and secondary bicycle driving battery as a secondary power source in addition to taking up power from a primary bicycle driving battery.

### Description of Related Art

It is known to provide a bicycle with an electric drive motor for driving the bicycle or for propulsion of the bicycle. The practice here is usually that pedal support is provided. With pedal assistance, the pedaling force of the rider of the bicycle is supplemented with a driving force by the electric drive motor. Use is made herein of a drive battery which is designed to supply sufficient electrical power to the drive motor. Said drive battery is a rechargeable battery of a type suitable for use in such a bicycle, for instance with a power between 100 Wh and 1000 Wh. The power that such a battery can deliver in a charging cycle is therefore limited, which limits the range in kilometers of the bicycle.

### SUMMARY OF THE INVENTION

In order to overcome such a drawback, the present invention provides a secondary bicycle drive battery for a bicycle as secondary, preferably external, energy source in addition to a primary bicycle drive battery as primary, preferably internal, drive energy source of the bicycle, for there with driving of a drive motor, the secondary bicycle drive battery comprising:
a housing,
fastening means that are connected or connectable with the housing for fastening of the housing to the bicycle, such as a frame thereof,
a predetermined number of battery cells,
a control unit, such as a BMS, such as for controlling of charging and discharging of the battery cells,
a voltage regulation circuit, such as a voltage stabilization circuit or a boost circuit, for controlling of a voltage of a secondary output current to a predetermined value for providing of an input current, such as via a charge connector, for the bicycle,
a charge current connection, such as comprising a current output connector or a charge cable, for providing of the secondary output current to the bicycle, such as to the charge connector thereof,
a communication unit for communication of a signal for the purpose of communicating of status information with regards to the secondary battery to the bicycle, such as to a BMS, communication unit and/or onboard computer thereof.

In this way it is advantageously realized that the range of the bicycle is increased using electric drive. A further advantage is that it can herewith be realized that the bicycle can distinguish between a mains adapter or mains charger and the secondary bicycle drive battery. This provides a solution to an aspect of functioning of the bicycle in combination with loading, considered by the present inventor in relation to the invention. The communication advantageously provides a form of identification of a charger that is capable of driving while connected via the bicycle charging connector, while this is precluded when a mains adapter is connected to the charging connector of the bicycle. Considered aspects of the invention and/or preferred embodiments thereof are directed to charging the primary bicycle drive battery from the secondary bicycle drive battery while stationary and/or driving, providing a drive current from the secondary bicycle drive battery to the drive motor of the bicycle.

The present invention is preferably related to the present applicant's practice of using a drive battery in the bicycle which is arranged in the frame, such as in a tube thereof, such as in the down tube. In addition, the present applicant makes use of an on-board computer battery for supplying energy to an on-board computer and/or at least one communication module for providing communication options to the on-board computer. This on-board computer battery provides for instance energy related to on-board computer facilities, such as bicycle lighting, lock facility, sound facility, screen and the like. This on-board computer battery is advantageous here because this part on-board computer and/or said on-board computer-related facilities can provide energy with an adapted voltage other than the voltage of the drive battery, preferably wherein the drive battery is rechargeable from the drive battery or directly from the bicycle's charging connector. For charging the primary drive battery and/or an on-board computer battery of the bicycle, the bicycle is provided with a charging connector according to the prior art.

A consideration underlying the present invention is that an advantageous implementation of a secondary bicycle drive battery utilizes this charging connector of the bicycle to provide electrical power to the bicycle. In this way it is advantageously provided that, according to the respective preferred embodiments, minimal adjustments to the bicycle are required using a secondary battery according to the present invention. Depending on the preferred embodiment, optional measures can be applied for this purpose, such as measures for protecting the secondary battery. Such measures are herein provided on the basis of which respective insights, always related to a respective preferred embodiment, with regard to advantages thereof in relation to the invention.

First preferred embodiment, the communication unit is arranged for communication with the bicycle via the charge current connection. Such communication is preferably provided between the secondary battery or a control unit thereof and the bicycle or an on-board computer or communication unit or BMS thereof. An advantage of such communication is that the bicycle can be informed with regard to status information of the secondary battery. This makes it possible, for example, to inform the rider of the bicycle with regard to this status, such as the amount of available load. This makes it possible for the rider of the bicycle to be informed, for example, as to the amount of charge available from the drive battery and the secondary battery separately or in combination.

A further advantage of this is that the bicycle, the on-board computer and/or the BMS thereof can determine on the basis of the communication whether the external battery is a known or previously registered one. Alternatively, on the basis of such communication, for example, a serial number of the external battery is available on the bicycle, the on-board computer and/or its BMS or this serial number can be forwarded to a central server, such as from a service provider or the manufacturer. In a further alternative manner, acceptance of a charging current from the external battery is permitted or denied on the basis of which the notoriety or pre-notification of the external battery, or such charging current for a limited number of charging cycles or rides are accepted. Also, the person who has purchased the secondary bicycle drive battery can, for example, sign up other users to use his copy via a sharing function, such as via a server from the manufacturer of the bicycles and/or the batteries.

According to a further preferred embodiment, of the secondary bicycle drive battery, the communication unit is arranged for communicating by means of the signal over the charge current, such as by varying a parameter of the charge current, such as voltage or current, such as by means of a series of charge current pulses or charge current interruptions. An advantage of such a preferred embodiment is that the bicycle can thereby identify the secondary battery as being such a secondary battery, and thus a device on the power of which, the bicycle can be driven while connected to the charge connector of the bicycle, and/or enabling charging of the driving battery while it is possible to drive the bicycle. It is hereby provided that the bicycle, a charger, BMS or on-board computer thereof detects and/or recognizes these parameters of the charging current in order to be able to switch to corresponding functioning, such as the possibility of charging or taking up drive current while driving the bicycle. This makes it possible to use the secondary battery with a bicycle without separate communication functions by, for example, adapting the firmware of the charger, BMS and/or on-board computer thereof in order to detect these variations via existing measurement modules. of current, voltage or functioning using, for example, pulse-width functionality such as pulse-width modulation.

According to a further preferred embodiment, the communication unit is arranged to communicate by means of the signal during a switch-on sequence or starting during the switch-on sequence for a predetermined time. This advantageously provides that immediately when the secondary battery is switched on, a communication signal is provided for the bicycle, such as an on-board computer, BMS or communication module thereof. With this, the bicycle is informed of the nature of the charger as a secondary bicycle drive battery for use thereof to charge the primary bicycle drive battery and/or to provide a driving current to the drive motor. The signal is also continuously defined, with the advantage that a missed initial signal is still confirmed. If an initial signal were missed, the bicycle with a coupled secondary battery that would have been detected as a mains adapter would refuse to drive. With still receiving a repeated signal, the bicycle can still function in a manner that is contemplated according to the present invention using the secondary battery. A further advantage is that it allows status information during use and/or connection of the secondary battery to be sent to the bicycle and received by the bicycle. To this end, the communication unit is preferably adapted to communicate by means of a signal spread over a period that the external battery is switched on and coupled to the bicycle by means of the charging current connection.

According to a further preferred embodiment, the communication unit is adapted to communicate by means of the signal, such as by means of modulation means, preferably comprising means for modulating a phase of the signal. Advantageously, such a data signal is independent of the parameters of the charge current. Such a data signal is provided as continuous during use of the secondary battery. Use of the secondary battery is herein envisioned, as in further preferred embodiments, as during a period of time that it is connected to the bicycle, such as through the charge current connection to the charge connector of the bicycle. An alternative definition of how to use the secondary battery is a period of time that it is connected and, as a device, also turned on. A user can conveniently switch the secondary battery on and off and thereby determine whether it is being used to supply power to the bicycle via the charging connector.

According to a further preferred embodiment, the communication unit comprises means for phase shift modulation or binary phase shift modulation, further preferably using a self-clocking or self-synchronizing signal, further preferably embodied as Manchester code. An advantage of such means for communication is that the signal comprising data synchronizes itself. As a result, such a signal can be used in combination with the above-mentioned preferred embodiments. Further means for synchronizing, such as by means of a separate signal, are therefore advantageously not required.

According to a further preferred embodiment, the communication unit is arranged for wireless communication, such as a short range wireless channel for communication in a range up to 10, 100 or 200 m, such as using a module for Bluetooth or Wifi. Advantageously, communication via mobile networks is also provided as a wireless option by means of a suitable module. Using such wireless communication, communication between the secondary bicycle drive battery and the bicycle by means of a module for Bluetooth or hi-fi thereof is provided as well as communication between the secondary bicycle drive battery and a mobile device, such as the rider's telephone, preferably one that has a connection to the bicycle which in this way is able to provide information by means of a screen which is coupled to the on-board computer of the bicycle, but also by means of the mobile device. It is also provided that any data communicated from the secondary battery to the mobile device is passed from the mobile device to the bicycle. In that way, also display on a screen of the bicycle is considered. To this end, the information communicated is preferably received by the bicycle via a communication module of the bicycle and subsequently processed by the on-board computer for display, or inclusion thereof in a display, on the display screen of the bicycle.

According to a further preferred embodiment, the secondary bicycle drive battery comprises a current level controller for controlling and/or measuring the current intensity, preferably at a predetermined current level, of the secondary output current. The predetermined current strength preferably corresponds to the current strength of a mains power adapter supplied or provided with the bicycle. An advantage of this is that the charging current is substantially equal to the charging current supplied from the mains current. An example of a power adapter capacity is a charging current of 4 A at 42 volts. The parameters are choosable below and above this value, such as between 2 A-10 A and/or between 15 volts-80 volts, in any combination thereof. The preferred equal charging current from the secondary battery provides the advantage that a bicycle charger and/or bicycle BMS with a device for those parameters of the charging current can function with both sources. It is further provided that this charging current can advantageously be passed directly from the secondary battery to the drive motor, irrespective of the charge present in the drive battery. If the drive battery is relatively full, the current draw is preferably distributed between the drive battery and the secondary battery such that the secondary battery delivers maximum power. This minimizes the discharge of the drive battery, reducing the need for the drive battery to be recharged from the secondary battery.

According to a further preferred embodiment, the fastening means are arranged for arranging the secondary bicycle drive battery at the location of an internal angle between two frame tubes, such as between two frame tubes of the frame, such as a diamond frame, preferably between the seat tube and the down tube. In this way, an empty space of a bicycle is usefully utilized in an advantageous manner. A further advantage is that the secondary battery is arranged at a relatively low position of the bicycle, which contributes to a low center of gravity of the bicycle.

According to a further preferred embodiment, the fastening means comprise a lock assembly for securing the secondary bicycle drive battery to the bicycle, preferably by means of a lock. This advantageously realizes that the secondary bicycle drive battery can be safely arranged with respect to the bicycle, since the lock assembly prevents removal without decryption means or occurs with a time delay and/or requiring breach.

According to a further preferred embodiment, the fastening means comprise a docking assembly for mounting it to the frame of the bicycle, such as at the internal corner between two frame tubes, preferably wherein the lock is arranged at the docking assembly. An advantage of such a docking assembly, dock or docking station is that it can remain mounted or mounted at a position of use of the secondary bicycle drive battery. In this way it can be realized in an advantageous manner that positioning operations of the secondary bicycle drive battery can be relatively simple or can be arranged relatively simply. A combination of a lock with a coupling assembly creates a variant with the combined advantages. For example, it is provided to arrange a lock in the coupling assembly with a relatively simple engagement means on the secondary bicycle drive battery or to arrange a lock in or on the secondary bicycle drive battery with a simple engagement means arranged in or on the docking station. Such a lock is provided as a lock that is operated from or by the on-board computer, a mechanical lock, or a lock that is operated from or by an application on the mobile device or telephone of a rider or owner of the bicycle.

For example, an embodiment is provided herein comprising a lock engaging member, such as a bolt receiving opening, locking pin receiving opening or eye, for engagement with the lock, such as with a bolt or locking pin thereof.

According to a further preferred embodiment, the fastening means comprise at least one support member for supporting against a frame tube of the bicycle, preferably wherein such support member comprises a plastic material, such as a resilient plastic or a foam material. This advantageously realizes that fastening means or a coupling assembly thereof can be arranged relative to the frame, while damage to the frame can also be prevented. Furthermore, a resilient material provides a firm ‘seat’ of the secondary drive battery relative to the frame, for example in that the resilient material is arranged under some bias relative to the frame while the secondary bicycle drive battery is positioned relative to the frame.

According to a further preferred embodiment, the secondary bicycle drive battery comprises an operating assembly for user operation, such as for switching on, switching off, changing setting, or resetting. It is herewith advantageously possible for the user to determine whether and when use is made of the charge of the secondary bicycle drive battery, when it is discharged and when its charge is retained.

According to a further preferred embodiment, the housing comprises a basic housing for holding electrical and/or electronic components, preferably further comprising a cladding housing and/or mounting housing for cladding and/or mounting the basic housing to the bicycle. For example, it is provided here that the basic housing is a housing for the battery cells and related electronics, which protects the product against weather influences and, for instance, moisture. The cover housing is furthermore advantageously instrumental for the attachment to the frame of the bicycle and for example support of the support member.

A further aspect according to the present invention relates to a method of controlling a secondary bicycle drive battery for a bicycle as a secondary, preferably external, energy source in addition to a primary bicycle drive battery as the primary, preferably internal, driving energy source of the bicycle for driving a driving motor therewith, the method comprising—the steps for:
sending a communication message from the secondary bicycle drive battery to the bicycle, such as an on-board computer, BMS, communication module thereof or primary bicycle drive battery thereof,
providing a charge voltage for a charge current for the primary bicycle drive battery. Such an aspect provides advantages as described with reference to an above aspect of the present invention.
   Further preferably, a preferred embodiment of a method comprises one or more steps of:
allowing the charge current to be taken up by the bicycle, its BMS or primary bicycle drive battery,
monitoring the magnitude of the charge current continuously or at predetermined intervals,
switching off the charge current and/or the secondary bicycle drive battery in the event of a determination that the charge current is below a threshold value.

A further aspect according to the present invention relates to a driving method of controlling a bicycle having a primary bicycle drive battery and a secondary bicycle drive battery for drawing power from the combination of primary driving battery and secondary bicycle drive battery as a secondary energy source in addition to drawing power from a primary bicycle drive battery, the method comprising steps for:
detecting connecting of the secondary bicycle drive battery to a charge port of the bicycle,
receiving a message including a charging status and/or identification of the secondary bicycle drive battery,
taking up power from the secondary bicycle drive battery for the primary bicycle drive battery and/or a drive motor.

According to a further preferred embodiment, with this, the communication between the secondary bicycle drive battery and the primary bicycle drive battery is performed over a charge current connection, such as comprising a power output connector or a charge cable from the secondary bicycle drive battery to the bicycle, such as via the charge connector thereof.

Further preferably, the communication between the secondary bicycle drive battery and the primary bicycle drive battery is performed by means of a signal according to preferred embodiments.

Further preferably, the communication between the secondary bicycle drive battery and the primary bicycle drive battery is performed by means of a wireless communication protocol, such as a short range wireless channel for communication in a range of up to 10, 100 or 200 m, such as using a module for Bluetooth or Wifi.

Further preferably, the method comprises steps of blocking or switching off of a charge current between the secondary bicycle drive battery and the primary bicycle drive battery in case of incorrect authentication of the secondary bicycle drive battery.

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

### BRIEF DESCRIPTION OF THE DRAWINGS

The terms Fig., Figs., Figure, and Figures are used interchangeably in the specification to refer to the corresponding figures in the drawings.

FIG. 1 is a perspective view of a first preferred embodiment of the present invention.

FIG. 2 is an exploded view of the preferred embodiment of FIG. 1 along substantially a centerline thereof.

FIG. 3 is an exploded view of the preferred embodiment of FIG. 1 along a further section line.

FIG. 4 is a further exploded view of the preferred embodiment according to FIG. 1 along a sectional line substantially adjacent to an outer side of a frameless inner housing.

FIG. 5 is a bottom view of the preferred embodiment according to FIG. 1 without coupling assembly.

FIG. 6 is a bottom view of a coupling assembly according to the preferred embodiment of FIG. 1 and a front view of the coupling assembly.

FIG. 7 is a schematic representation of a charging scenario and a driving scenario of a secondary bicycle drive battery according to the present invention or preferred embodiments thereof.

FIG. 8-9 are a flow chart of a preferred embodiment of the present invention.

FIG. 10-11 is a further schematic of the preferred embodiment of the present invention.

FIG. 12-15 relate to further preferred embodiments of the present invention.

FIG. 16 provides a schematic representation of a modulation according to a preferred embodiment, as according to claim 7.

FIG. 17 is a schematic representation of a further preferred embodiment according to the present invention.

FIG. 18 is a schematic representation of a further preferred embodiment according to the present invention.

FIG. 19 provides to side views of a further preferred embodiment according to the present invention.

FIG. 20 provides a side view and to perspective views of details of the embodiment of FIG. 19.

FIG. 21 provides a side view and a perspective view of further details of the embodiment of FIG. 19.

FIG. 22 to provides a perspective view of further details of the embodiment of FIG. 19.

FIG. 23 provides an exploded view in perspective of further details of the embodiment of FIG. 19.

### DESCRIPTION OF THE INVENTION

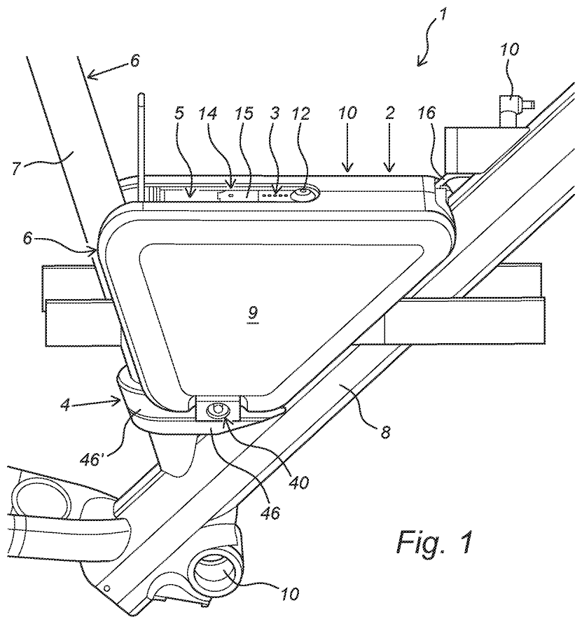

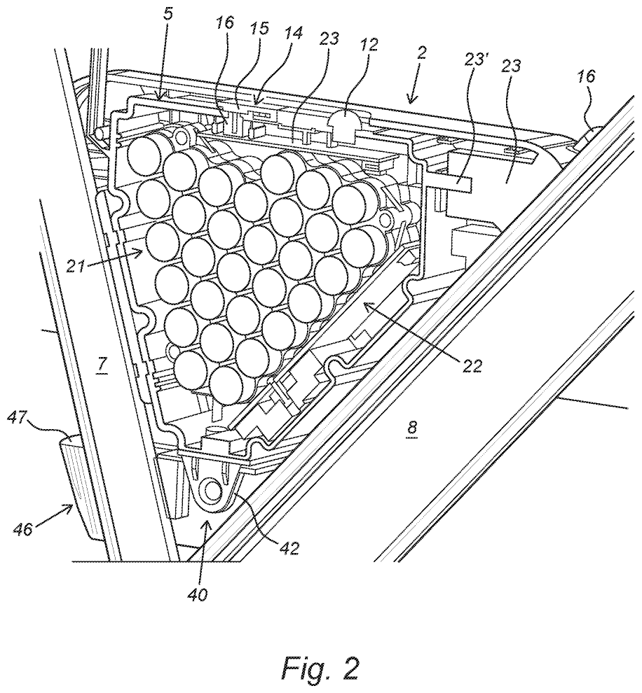

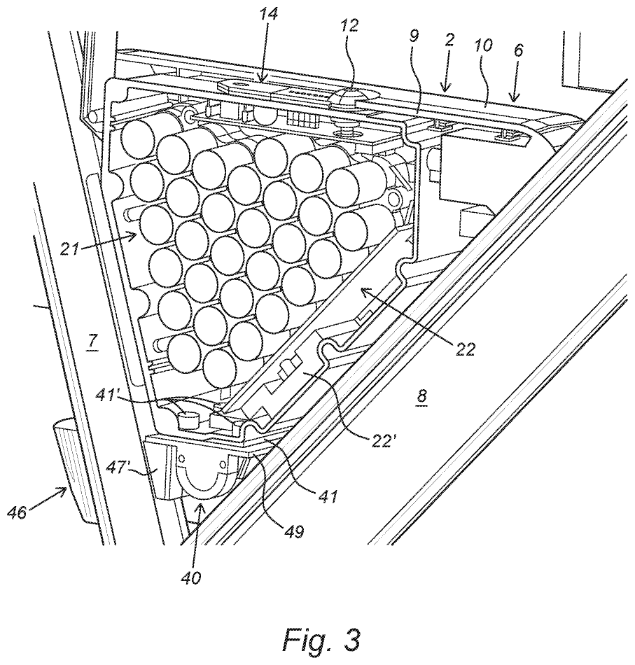

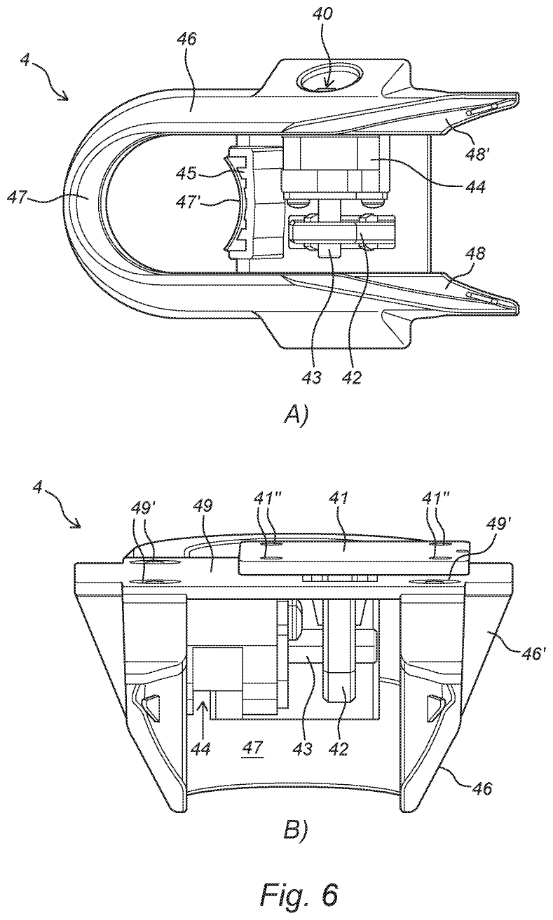

A first preferred embodiment (FIG. 1-6) according to the present invention relates to a secondary drive battery 1 for a bicycle. The secondary drive battery 1 generally comprises of a battery assembly 2 and a docking assembly 4. The battery assembly 2 generally provides the battery function of the secondary drive battery and the docking station 4 provides a secure mounting unit for secure arrangement on the bicycle of the battery assembly. For the purpose of connecting the secondary drive battery to the bicycle, it is provided with a charging current connection by means of a cable 16 with a plug 10 for insertion thereof into a charging connector of the bicycle, preferably the charging connector for charging of the primary bicycle drive battery 8″ of the bicycle. In current models of the present applicant, such a bicycle charging connector is arranged at the underside of the top tube of the frame so that it is advantageously accessible from the top of the secondary drive battery by means of the cable 16. In this case, the top tube is further provided with an on-board computer 3, also referred to as main control unit or smart module, for performing control functions of the bicycle.

A communication unit of the secondary bicycle drive battery is also part of the electronics. This communicates either via the cable 16 with the bicycle, or via a wireless connection, such as Bluetooth or WiFi, in which case a suitable communication module is included in the electronics, preferably on an I/O printed circuit board 23.

This secondary drive battery serves to provide power to the bicycle in addition to a primary drive battery 8″ arranged in the down tube 8. To this end, this secondary drive battery 1 is arranged in the V-shaped space between the down tube 8 and the seat tube 7. According to this preferred embodiment, a charge current from the secondary drive battery is provided to a charge connector that charges the primary drive battery from a mains power adapter. Alternatively, a connection between the secondary drive battery and the bicycle is provided to provide direct connection to the primary battery, the BMS thereof or a drive motor.

The housing of this preferred embodiment has a base housing, inner housing or primary battery housing 5 within which electrical and/or electronic components comprising a battery cell assembly 21 as well as a battery control system 22 such as comprising a driver unit, voltage regulation circuit and/or current regulator are located. A Base housing, inner housing or primary battery housing is used to house and/or protect these electrical and/or electronic components. For instance, this housing is preferably of watertight design. This housing substantially consists of 2 shell shaped elements, which are mounted and closed by means of a multiple screw connection 13.

At the top of this base housing is a control panel comprising an operating button 12 for which interaction operations such as switching on/off the secondary drive battery 1. In addition there is a visual battery charge indicator 3 in the form of five LED's, but also a display for graphical elements or alphanumeric elements such as a value between 0 and 100 is considered. In addition, there is a charging assembly 14 comprising a charging connector 16 and a cover 15 thereof for sealing against dirt and moisture. Below the control panel is the I/O printed circuit board for providing I/O functions via the control panel and the charging connector. To this end, the charging connector 16 is mounted on the I/O printed circuit board, as well as a switch that is operated by means of the button 12.

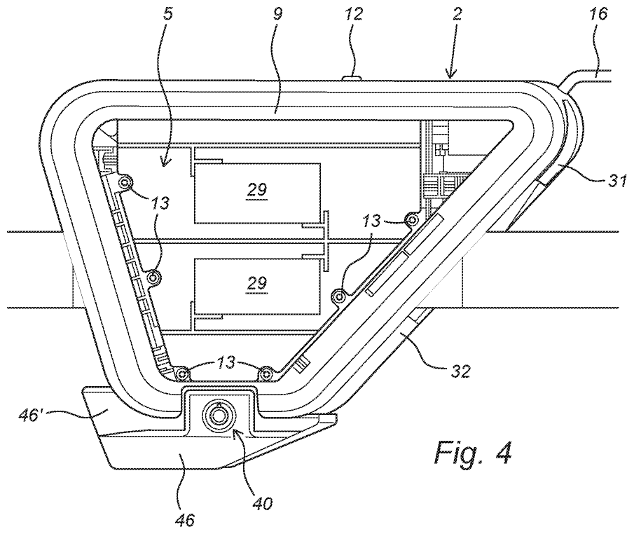

For the purpose of protecting the base housing and/or mounting the secondary drive battery to the frame, such as the down tube 8 and the seat tube 7 thereof, an outer housing substantially formed by the shell parts 9, 10 is also provided. One of these shell parts is that the secondary drive battery is relatively easy to personalize with respect to the type or model of bicycle or with respect to the taste of a user of the bicycle. As seen in the exploded view of FIG. 4, which is cut away along a cutting plane just outside the inner housing 5, the outer housing is mountable by means of double-sided stickers 29 arranged within preferred indication lines on the outside of the inner housing. In this drawing, a number of elements of the screw connection 13 are also clearly shown.

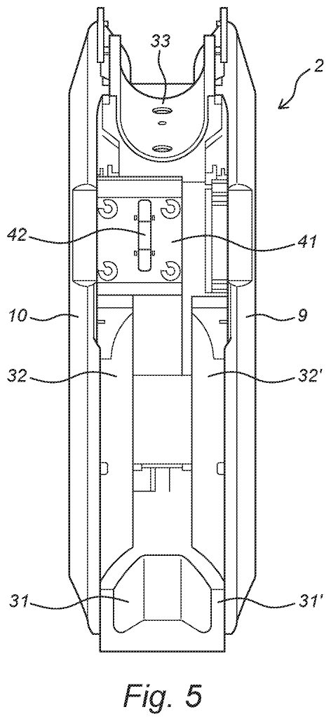

The inner housing 5 is further provided with a connecting element 23′ for insertion thereof into a support block 23 for bearing on the down tube 8. The support block 23 is connected to or provided as part of a support element 31, 32 which is shaped to fit the to support against the down tube. An advantageous and stable arrangement against the down tube is herewith realized. This support element 31, 32 is preferably manufactured from a soft plastic and/or foam material, the feature of which to give way is limited by the shell parts 9, 10. Also relative to the seat tube 7, such a support is provided for the secondary drive battery. provided in the form of support element 33. These support elements 31-33 are advantageously visible in FIG. 5.

At the underside of the inner housing is a base plate 41 with a lock eye 42 attached thereto for cooperating with a bolt or latching on of a lock of the docking assembly 4. This base plate is attached to the base housing 5 by means of a screw connection 41′. Behind the base plate 41 is a connector for connecting the battery control system or components thereof to a maintenance computer, such as for updating firmware.

The docking assembly 4 is arrangeable and mountable to the frame at preferably the top of the junction between the down tube and the seat tube. The docking assembly can be fixedly mounted on site by means of an enclosure of the seat tube, which connection is fixed by means of a fixing plate 49 which is fixed by means of a screw connection 49′. For support by the down tube, two support elements 48, 48′ are provided at the location of the down tube, which support elements extend substantially arm-shaped from the attachment around the seat tube. The connection around the seat tube is mainly performed by means of the basic elements 46, 46′, wherein the fixation relative to the seat tube is realized by means of the screw connection 41″ relative thereto. For the purpose of protecting the frame, resilient and/or foam-shaped elements 47, 47′ are provided.

In the position in which the docking assembly 4 is arranged at the frame, the docking assembly has a lock assembly 40 which comprises 49 a lock 47 below the fixing plate, which functions by means of a lock pin 43, such as a locking pin or a bolt. The lock 47 is operated by means of a key along key input 40. It is alternatively provided that the lock is operated by the on-board computer of the bicycle. It is hereby possible for a user to operate the lock via an application 11 which functions on a mobile device, such as a mobile telephone of the user of the bicycle. For the lock assembly 40 to function, the lock pin is moved from the position shown in which it protrudes through the eye 42 of the base plate 41 to a position in which it no longer protrudes through the eye 42 of the base plate. This is achievable by the mechanical action of the lock 47. Alternatively, a solenoid is provided for this purpose in the place of the lock 47 to actuate an equivalent of the lock pin therewith.

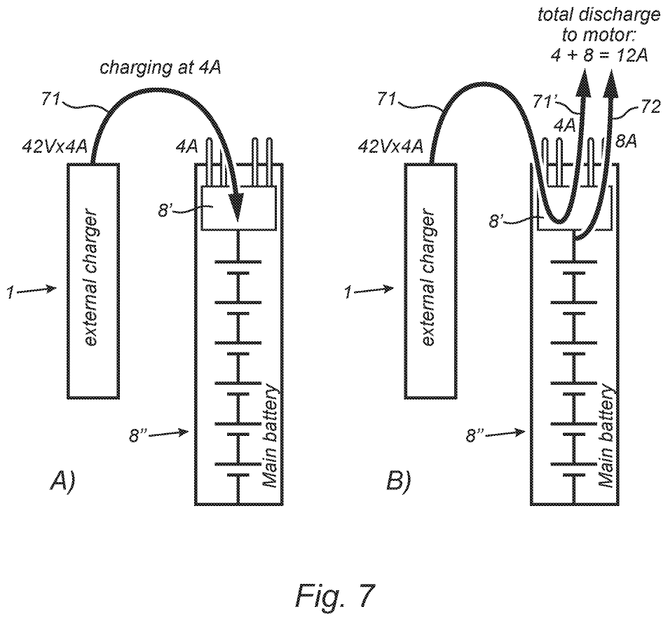

FIG. 7 shows two functional scenarios for use of the external battery 1. As a preferred embodiment, it is assumed here that the external battery 1 emulates a mains adapter in the sense that it provides a charging current to the bicycle that corresponds thereto, such as, for example, a charging current of 42 volts at 4 A. A consideration here is that the existing battery charger that is located in the bicycle or in its BMS can be used with the external charger without modifications. It is hereby provided that the secondary drive battery functions as a power source for the charger of the primary battery 8″ in the down tube 8 as shown in FIG. 7A. In this scenario, the primary battery will charge when for example power is not supplied to the drive motor. This ensures that as much charge as possible is transferred from the secondary drive battery to the primary drive battery. An advantage of this is that the charge is present as much as possible in the primary drive battery of the bicycle, while the secondary battery can be charged whenever this is possible. Such charging of the primary drive battery is for example possible while the bicycle is active but does not require engine power, i.e. the bicycle is in a sleep mode or off mode.

An alternative envisioned scenario according to FIG. 7B is also aimed at preserving as much charge as possible in the primary battery and making maximum use of the secondary battery. In this scenario, engine power is requested and delivered. When the secondary battery has sufficient charge to supply the charging current, this charging current is passed on directly to the drive motor of the bicycle. In case there is also still sufficient charge present in the primary drive battery of the bicycle, a drive current is also supplied from this primary battery to the drive motor. Since the amperage of a mains adapter is limited to a standard value, such as the 4 A mentioned in this example, within the scope of the present preferred embodiment, the current of the secondary drive battery is also limited to this for driving the motor. Therefore, if more power is required from the engine than can be supplied on the basis of the charging current of an external charger, this is provided by the BMS from the primary drive battery at the request of the on-board computer. Also in this scenario the advantage is provided that the uptake from the primary drive battery is reduced using the secondary drive battery. This also ensures that the amount of charge in the primary drive battery remains at a maximum in this scenario.

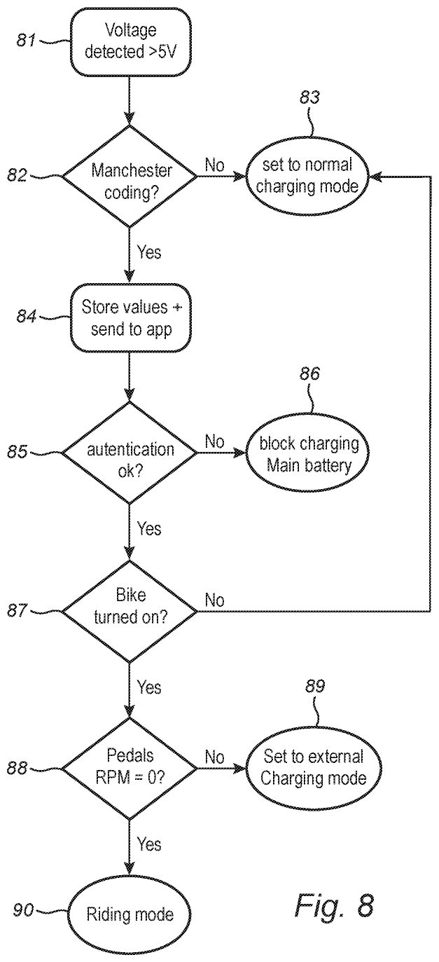

FIG. 8 shows a preferred embodiment of a method related to the on-board computer of the bicycle. In step 81, a voltage, such as greater than 5 volts, is detected on the charging connector of a voltage suitable for data transfer, such as by a Manchester encoding, and/or suitable for charging the primary bicycle drive battery. In step 82 it is determined whether there is a signal involving data transfer on the incoming signal with the detected voltage. If not, the battery charger for the primary bicycle drive battery is set to a normal charging mode. If it is determined in step 82 that there is a signal containing data transfer, in step 84 the transferred data and/or its value is stored and/or transferred to an application on a mobile device of the user.

Then, in step 85, it is determined whether the authentication of the secondary bicycle drive battery is OK. This means that it is checked whether the battery has previously been registered with the bicycle. In this way it can be prevented that an illegally obtained or connected battery is used for charging the primary bicycle drive battery. With such a measure, the safety of all secondary bicycle drive batteries is increased, such as because purloining therewith is pointless. In step 86, therefore, the battery is disabled from charging the primary bicycle drive battery and/or drawing power therefrom for the purpose of driving the motor.

In step 87, it is determined whether the bicycle is turned on. This means, for example, that the on-board computer is activated by the user to, for example, release a lock and activate subsystems of the bicycle. If it is determined in step 87 that the bicycle is not turned on, then the method is continued in step 83 with a normal charging mode, i.e. for charging the primary battery from the secondary battery. If it is determined in step 87 that the bicycle is turned on, it is determined in step 88 whether the pedals have a rotational speed of 0. If this is the case, an external charging mode is set in which the primary battery is charged from the secondary battery. If it is determined in step 88 that the pedals do not have a rotation of 0 and thus rotation is passed to the driving mode where energy from the secondary battery is supplied to the drive motor.

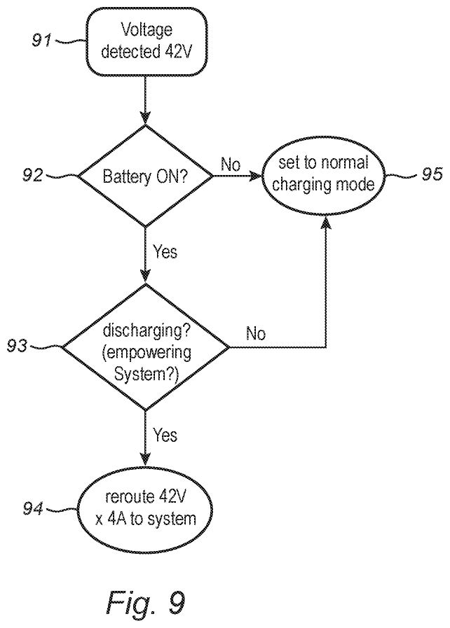

In FIG. 9 is an exemplary method of detecting a charging voltage by the primary bicycle drive battery is shown. In step 91, a voltage of a predetermined value such as 42 volts is detected. As mentioned, this value corresponds, for example, to a charging voltage from a mains adapter for charging the battery. In step 92, it is detected whether the battery is turned on. If this is not the case, a normal charging mode is set. If the battery is turned on, it is determined in step 93 whether it is discharging, and thereby whether it is supplying power to the system. If it is determined in step 93 that the battery is not discharging, it is set to a normal charging mode based on the detected voltage. If it is determined in step 93 that the battery is discharging, such as by supplying power to the system, then in step 94, the power from the detected voltage is passed to the system. In other words, with this the motor is driven. As mentioned above on the basis of the scenarios according to, for example, FIG. 7, a nominal power of a mains adapter is preferably used, such as a current of 4 A at 42 volts. In this way, the amount of charge is advantageously not withdrawn from the primary battery, but from the secondary battery.

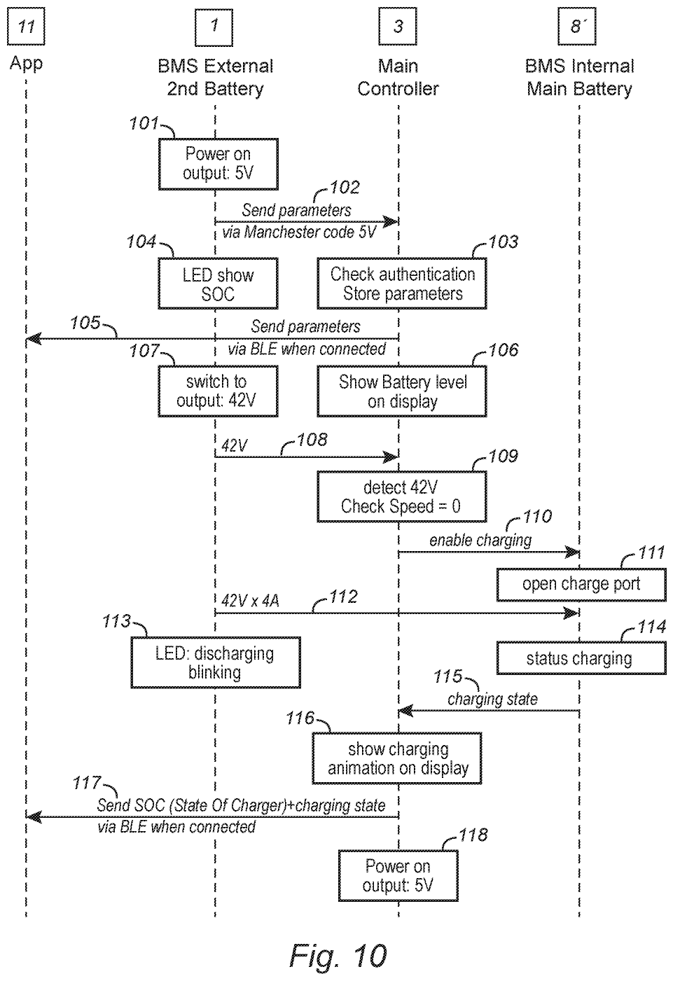

FIG. 10 shows a communication method between the on-board computer 3, BMS of the primary bicycle drive battery 8′, a BMS of the secondary bicycle drive battery, and an app on a user's mobile device. In step 101, the secondary bicycle drive battery is turned on. This starts by sending parameters in a data communication 102 via the charging cable using, for example, a modulated signal such as Manchester code over a voltage of 5 volts to the on-board computer 3. In step 103, the authentication sent with the secondary battery is applied. checked and parameters are saved. In step 104, the charge level (SOC) of the secondary external battery is displayed on the control panel of the secondary external battery by means of said LEDs. At step 105, parameters are communicated to an application on a rider's mobile device when it is connected. Such a connection is preferably carried out by means of a variant of Bluetooth such as BLE. In step 106 the battery level is displayed on its screen by the on-board computer.

Also, the external bicycle drive battery 1 switches to an output voltage of 42 volts in order to supply maximum rated power equivalent to a mains adapter in combination to the primary battery and/or the drive motor and communicates it in step 108 to the on-board computer 3. The on-board computer detects the voltage of 42 volts switched on by the external battery and monitors the rotational speed of the pedals. When it is 0, a charging instruction 110 is communicated to the BMS of the primary battery, as a result of which, in step 111, the BMS of the primary battery opens a charging port.

The BMS of the secondary bicycle drive battery communicates charge current parameters of 42 volts times 4 A to the BMS of the primary battery through communication 112. Next, the BMS of the primary battery determines the status of charging in step 114. During this, LED's of the secondary battery indicate discharging of the secondary battery in favor of charging the primary battery. The BMS of the primary battery communicates the latest state to the on-board computer by means of communication 115. Thereupon, the on-board computer 3 communicates the charging to the user by means of a charging animation on the display in step 116. When a connection is active, the on-board computer sends the charging state and the state of the charging progress to the application on the rider's mobile device via BLE when connected by step 117.

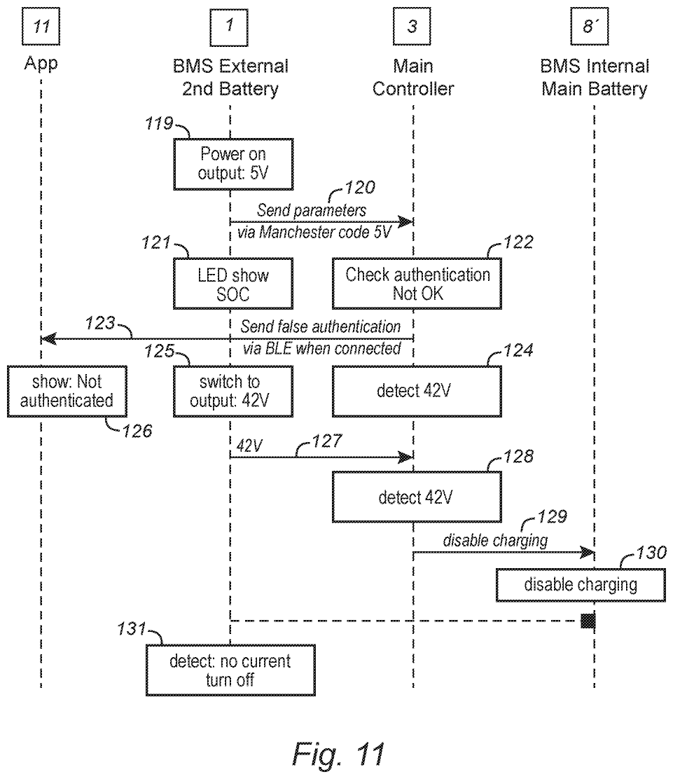

In FIG. 11, a communication method is shown between the on-board computer 3, BMS of primary bicycle drive battery 8′, a BMS of secondary bicycle drive battery and an app on a user's mobile device for blocking a secondary bicycle drive battery based on of an incorrect authentication. When the secondary bicycle drive battery is turned on, an output voltage of 5 volts is set for communication in step 119. In step 120, parameters are transferred via data communication via the charging cable using, for example, a modulated signal such as Manchester code over this voltage signal of 5 volts to the on-board computer 3. In step 122, the on-board computer 122 checks whether the authentication of the secondary drive battery performing the communication is known and, as a result, obtains that it is unknown. The display of the secondary bicycle drive battery also shows the percentage of charge in the battery. The on-board computer then sends the unknown authentication by means of communication 123 to the application on the mobile device of the rider as with which the bicycle was previously switched on. The user interface of the app shows on the display of the mobile device that the battery has not been authenticated in step 126. The BMS of the secondary bicycle drive battery switches to an output voltage of 42 volts in step 125 since it is unknowing of the negative authentication as performed by the on-board computer. The on-board computer detects this output voltage via the charging cable and the charging connector. Also, the BMS of the secondary battery communicates the switchover to the on-board computer in step 127. On the basis of the incorrect authentication, the on-board computer sends a communication to the BMS of the primary bicycle drive battery instructing it to stop charging. Then, in step 130, the BMS of the primary bicycle drive battery turns off charging. As a result, the BMS of the secondary bicycle drive battery detects that the charging current has fallen in the meantime under the threshold value mentioned elsewhere and switches off the secondary bicycle drive battery.

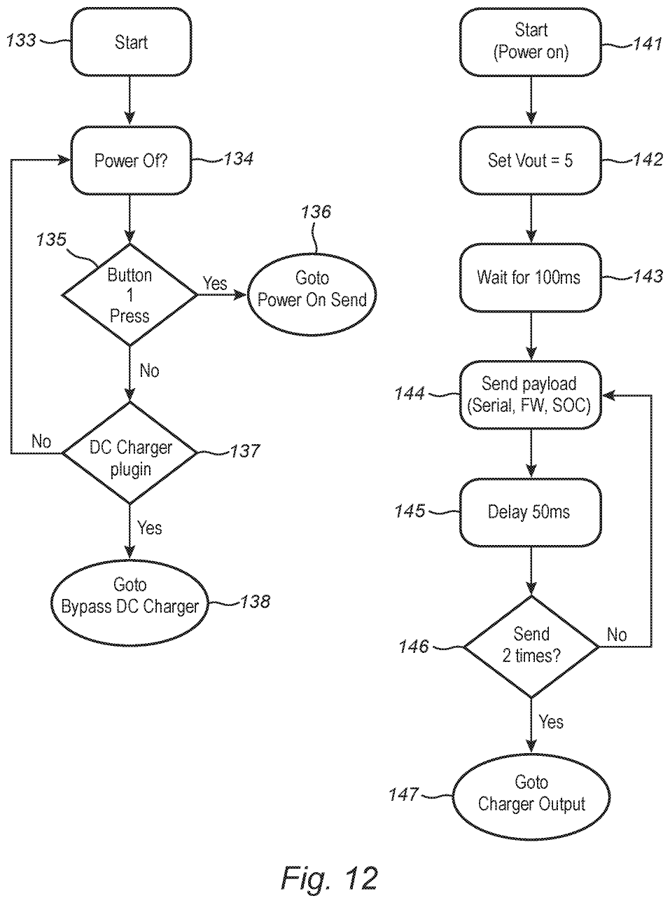

FIGS. 12-17 show methods performed by the secondary bicycle drive battery.

FIG. 12 shows two preferred embodiments of a secondary drive battery operation scenario. The method starts in step 133. In step 134 the secondary battery is turned off. During this shutdown condition, it supplies no power to the bicycle. In step 135, it is detected whether the on/off button 12 of the secondary battery is actuated. If not, it is detected in step 137 whether an AC adapter is coupled to charging connector 16. If not, the secondary drive battery remains in the off state. If an AC adapter is detected in the charging connector 16 in step 137, it proceeds to step 180. If it is determined in step 135 that the power button 12 of the secondary battery is actuated, it proceeds to step 141.

In step 141, the secondary drive battery is turned on by detecting the actuation of purchase 12. In step 142, an output voltage is set to 5 volts. This voltage is an example of the preferred embodiment and then be any voltage suitable for performing a communication between the secondary battery and the bicycle. In step 143, a wait sequence of preferably 100 ms is performed.

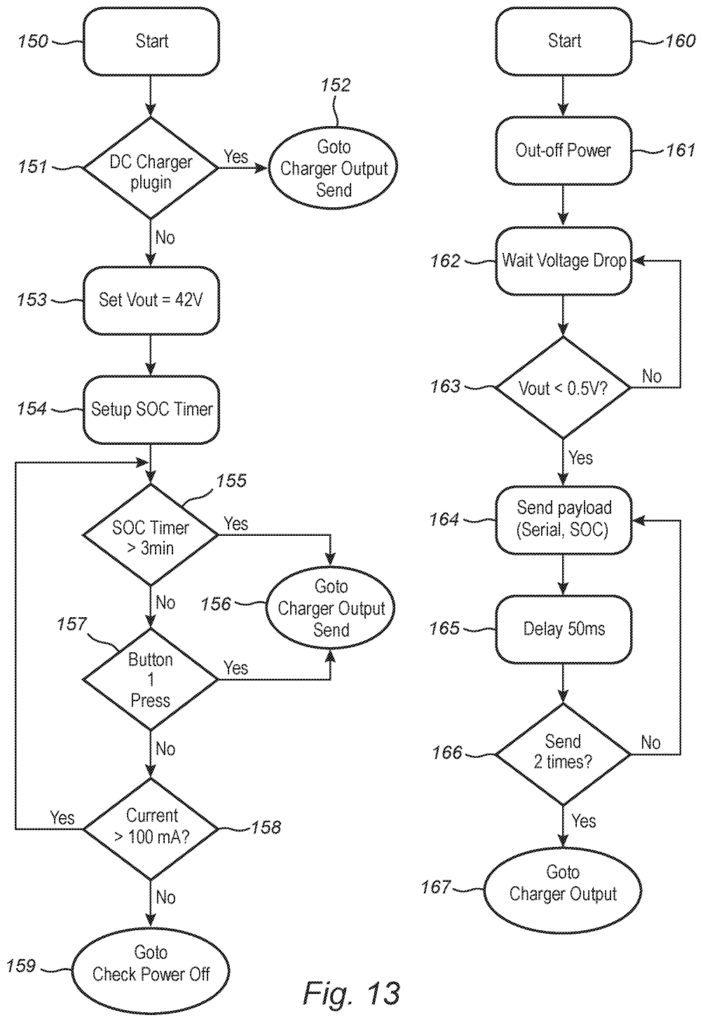

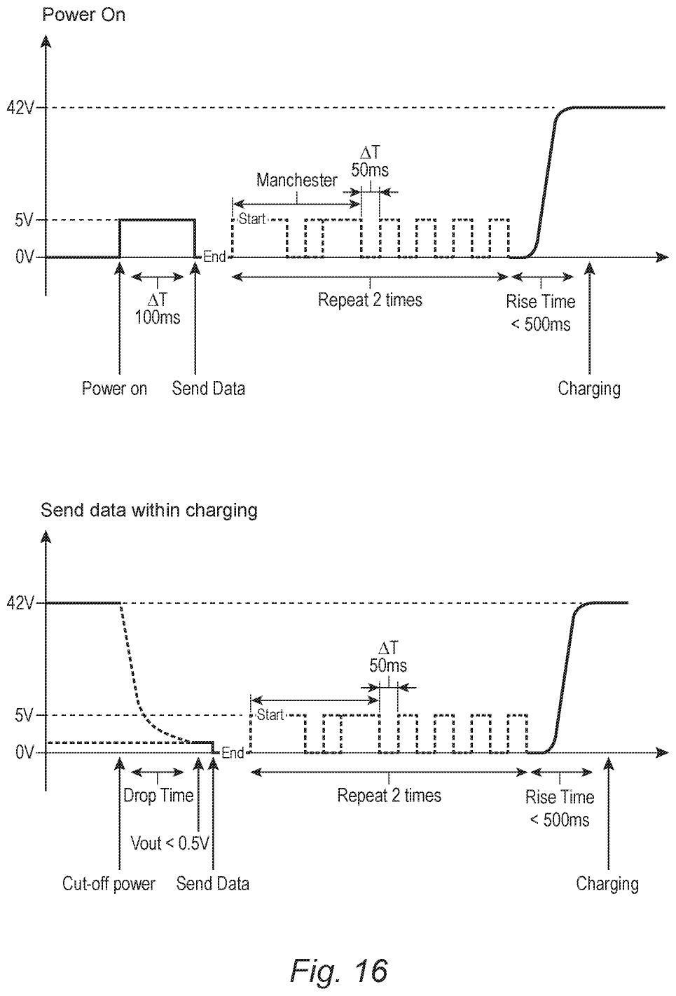

In step 144, functional information is transmitted to the bicycle, the functional information preferably comprising a serial number, a firmware number, or a state of charge value (SOC). When transmitting this information, use is preferably made of a phase modulated, further preferably self-clocking or self-synchronizing signal. An example of this is described below with reference to FIG. 16. In step 145, the delay is for a predetermined time such as 50 ms. In step 146, it is determined whether the signal is sent again. If this determination is positive, it is continued in step 144. If this determination is negative, it is continued in step 147. This is continued in step 150 of FIG. 13.

In FIG. 13 is a method of carrying out loading shown. At step 150, the method begins. In step 151, it is detected whether an AC adapter is plugged in. If this is the case, the method proceeds to step 160. If no mains adapter is detected, step 153 continues with setting an output voltage of a predetermined magnitude, in this example preferably 42 volts. Next, in step 154, a SOC timer is set. In step 155, it is determined whether the SOC timer is greater than 3 minutes. If this is the case, the method is continued in step 156 and a switch is made to step 160. If it is determined in step 155 that the SOC timer is smaller than 3 minutes, it is continued in step 157 with the determination whether the on/off switch is once pressed. If this is the case, step 156 also proceeds to step 160. If it is not determined in step 157 that the on-off switch is pressed once, it is determined whether the current is greater than 100 mA. If so, the method returns to step 155. If it is determined in step 158 that the current is less than 100 mA, the method proceeds to step 159 and proceeds to step 170.

In step 160, the method is started. In step 161, power is turned off. In step 162, a wait time is maintained for voltage drop. In step 163, it is determined whether the output voltage is less than 0.5 volts. If not, step 162 is repeated. If it is determined in step 163 that the output voltage is less than half a volt, the method proceeds to step 164. In step 164, information such as including serial number or battery charge is transmitted via cable 16 to the bicycle. In step 165 there is a 50 ms wait. In step 166, it is determined whether the information has been sent a second time. If it is determined that information is not sent a second time, the method is continued in step 164 with such a transmission. If it is determined in step 166 that the information has not been sent a second time, step 167 switches to step 150.

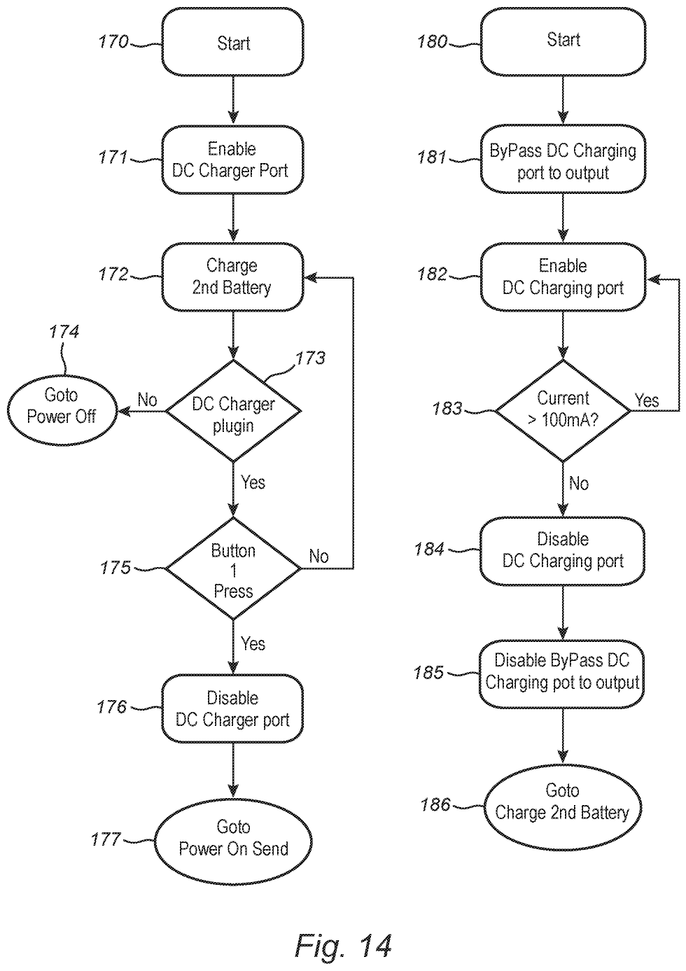

In step 170 the method according to FIG. 14 for the purpose of charging the secondary bicycle drive battery. In step 171, the DC charging port for the battery cells 21 is turned on. In step 172, charging of the battery cells is performed. In step 173, it is detected whether the mains charger plug is plugged in or still plugged in. If this is not the case, the secondary bicycle drive battery is turned off in step 174. If it is determined in step 173 that the plug of the mains charger is plugged in, step 175 detects whether the on/off button is pressed. If not, charging continues in step 172. If it is determined in step 175 that the button is pressed, the DC charging port is turned off in step 176. The method is continued in step 141 by means of step 177.

For the purpose of diverting the mains power adapter, a partial method is started in step 180. Its purpose is to charge the primary bicycle drive battery by means of the mains power adapter by means of the mains power adapter while it is connected to the secondary bicycle drive battery. In step 181, the charging current is switched to the output cable 16. In step 182, the DC charging port is turned on. In step 183, it is determined whether the current is greater than 100 mA. If this is the case, charging is continued in step 182. If it is determined in step 183 that the charging current is less than 100 mA, the DC charging port is turned off assuming that the primary bicycle drive battery is fully or substantially fully charged. In step 185, the bypass from the DC charging port to the output cable 16 is turned off or lowered. Step 186 is continued in step 170 for recharging the secondary bicycle drive battery.

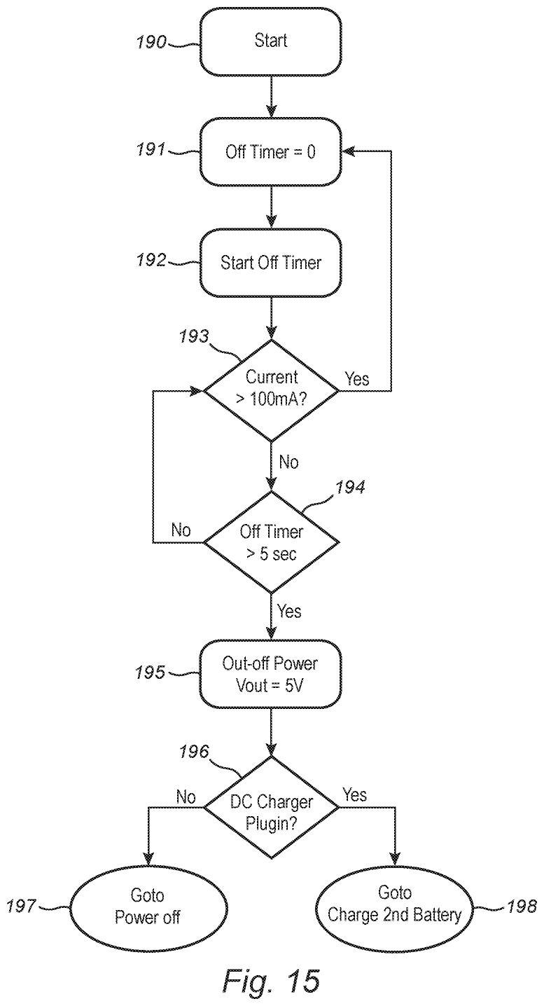

In step 190 the method according to FIG. 15 for the purpose of controlling shutdown of the secondary bicycle drive battery. In step 191, a turn off timer is reset to 0. In step 192, the turn off timer is turned on. In step 193, it is determined whether the charging current is greater than 100 mA. If this is the case, the method is continued in step 191. If it is determined in step 193 that charging current is less than 100 mA, it is determined in step 194 whether the switch-off timer is greater than 5 seconds. If this is not the case, the method proceeds to step 193 with the relevant determination. If it is determined in step 194 that the turn-off timer is greater than 5 seconds, the power is turned off in step 195 to an output voltage of 0 volts. Then, in step 196, it is determined whether the AC adapter is plugged in. If this is not the case, the power is switched off by means of step 197. If it is determined in step 196 that the mains adapter is plugged in, step 198 continues in step 170 for charging the secondary bicycle drive battery.

FIG. 16 shows a sequence of modulation of a communication from the secondary bicycle drive battery to the on-board computer via the charging cable. A communication starts with a delay by means of a constant high voltage for a predetermined period of time. Substantive communication then begins, after which a voltage change always represents an information unit. Here, a change from low to high represents a logic 0 and a change from high to low represents a logic 1. Such communication can be performed prior to a charging sequence wherein the communication is performed with a voltage of 5 volts after which the voltage is raised up to the example of 42 volts in order to be able to charge or transfer sufficient power with a sufficient amperage to the drive motor. During charging, to transmit information such as charge level of the secondary battery, the higher charging voltage is reduced to a voltage well below the communication value and a start pulse is given at the voltage of the communication value and then the data. After sending the data, such as the percentage charge of the battery, the voltage is increased back to the charging voltage. Preferably, the data message is repeated twice.

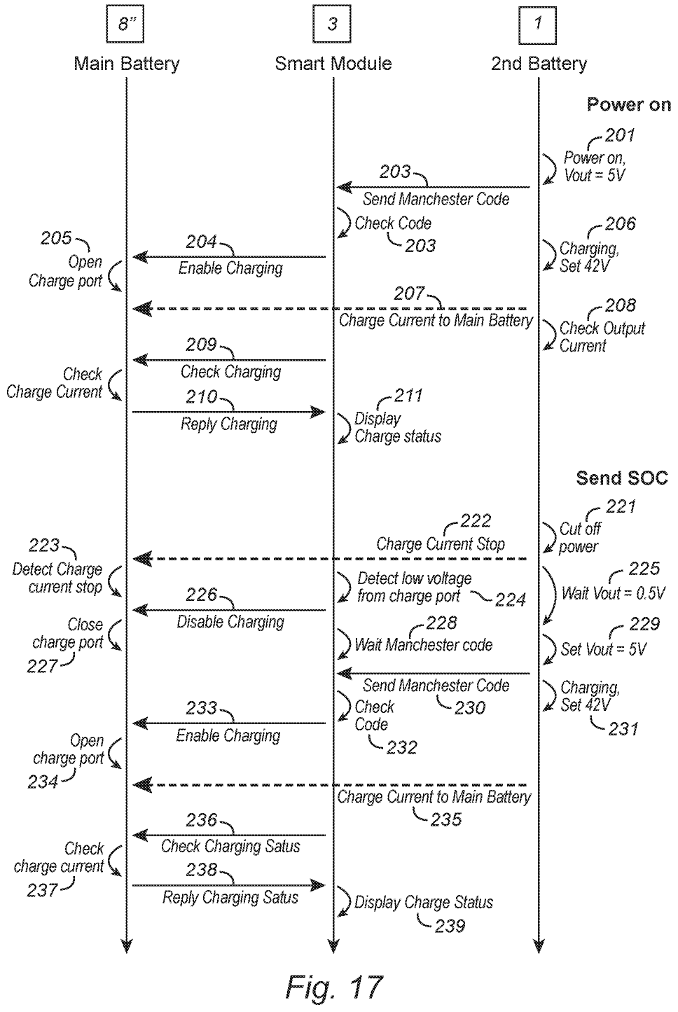

FIG. 17 shows the cooperation of the primary bicycle drive battery 8″, the on-board computer 3, possibly in combination with the BMS and/or a communication module as indicated above of the bicycle and the secondary bicycle drive battery 1.

In step 201, the secondary battery is turned on, such as by pressing the power button. In step 202, the data message is transmitted from the secondary battery to the on-board computer of the bicycle. In step 203, the received code is checked. In step 204, primary battery charging is turned on. In step 205, the loading gate is opened. In step 207, a charging current is supplied to the primary battery 8″. In step 208, the output stream is checked. In step 209, the on-board computer sends a message to the battery or BMS for charging control. In step 209′, the charging current is controlled by the battery or the BMS. In step 210, a message regarding charging is sent to the onboard computer. In step 211 the status of the charging is shown in a screen of the on-board computer. Alternatively, this charging status is transmitted to an application on a mobile device of the user for the purpose of displaying the charging status on the display of the mobile phone or rendering with sound via sound output from the mobile phone.

For the purpose of transferring the charge status of the secondary battery, the operation is preferably carried out as follows. In step 221, the power is turned off. In step 222, the charge current from the secondary battery to the primary battery is stopped. This method is performed so that the charging current is not communicated. In step 223, the primary battery senses that the charge current has stopped. At step 225, a low voltage of, for example, 0.5 volts is waited for in response to a power cut. In step 224, a low voltage from the charging port is detected by the on-board computer. In step 226, charging of the primary battery is turned off. In step 227, the charging port of the primary battery is closed. At step 228, an incoming communication is awaited, such as by Manchester code. In step 229, after reaching the lowest level voltage of e.g. 0.5 volts in step 225, an output voltage of e.g. 5 volts is applied. This voltage serves to communicate a message from the secondary battery to the bicycle. In step 230, using the applied voltages of 5 volts, a message is sent from the secondary battery to the on-board computer, such as by Manchester code. In step 232 the code is checked. In step 231, the secondary battery voltage applies suitable for charging such as said 42 volts. In step 233, the charging capability is passed from the on-board computer to the battery or its BMS. This is done on the basis of the completion of receiving the message. In step 234, the loading gate is opened. In step 235, based on the set charging voltage of, for example, 42 volts, the charging current to the primary battery is effected and the primary battery is charged. In step 236, the on-board computer sends a message requesting the charge status to the primary bicycle drive battery. In step 237, charging current is checked. In step 238 the charging current is sent in response to the on-board computer. In step 239, the battery charge status is displayed on the display.

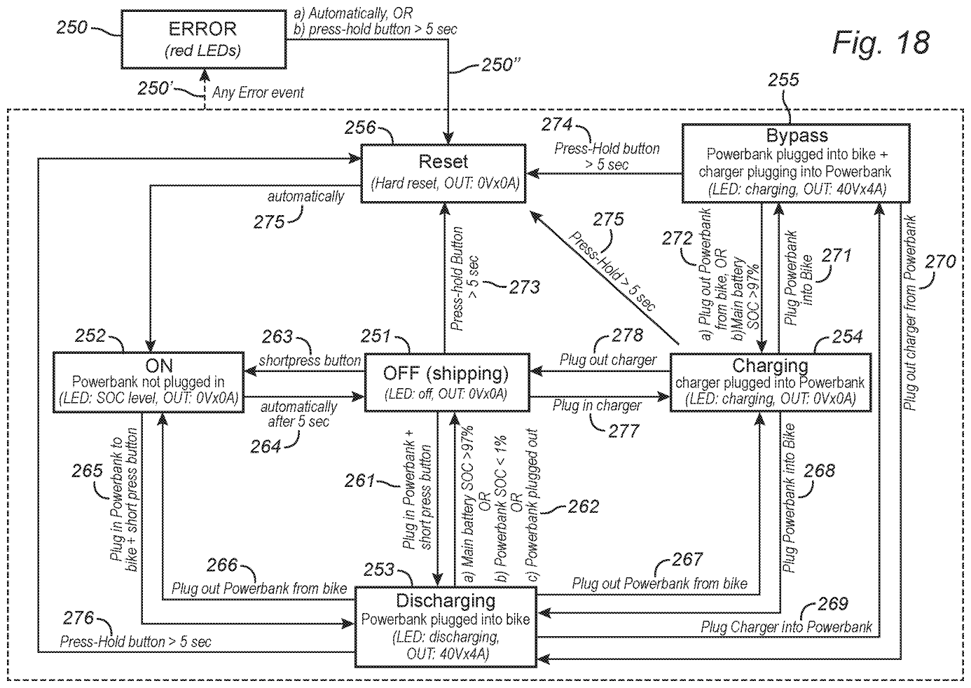

FIG. 18 shows a further combination of preferred embodiments schematically by means of states and possible transitions between states. This further explains examples of ways of using the external battery according to the present invention. These states are all optional states that are applicable depending on an implementation of a preferred embodiment in combination with any other optional state. With this, FIG. 18 shows a number of possible preferred embodiments and FIG. 18 not necessarily relates to an overall picture of a single complete preferred embodiment.

These states relate to a device according to the present invention being a secondary bicycle drive battery according to a preferred embodiment. Such a device has a user interface comprising a button and graphic indication means such as a number of LEDs. Furthermore, the option of a display screen or loudspeaker is provided. Via communication, as mentioned in the foregoing, it is provided that information can be displayed via a display screen of the bicycle to which the bicycle is connected to the secondary drive battery, and via an application on a mobile telephone, either directly via a communication module of the secondary bicycle drive battery, or via a communication module of the bicycle to which the secondary propulsion battery is coupled.

Such transitions may be actuated by an event or an operating action, such as pressing a button or inserting or removing a plug. Condition 250 represents an error condition with a display 250′ of an error, such as my means of one or more red LEDs or other visual or auditory output to, for example, a screen or speaker. Such output is represented by a communication 250′ indicating any error event as may occur in any of the states or in any of the operations of the art indicating the origin of the communication 250′ (251-276).

Assuming the state ‘turned off’ 251, which state indicates that the device being the secondary bicycle drive battery in some preferred embodiment has been turned off. From the ‘switched off’ state, the ‘switched on’ state 252 can be entered into by means of a user action 263 involving a short press on the said button of the device. In case no other state transition occurs for a predetermined time, such as within, for example, 5 seconds, after switching on 264 the device switches itself off automatically.

If from the ‘shut down’ state the mains charger or mains adapter is plugged 277 into the external battery, the external battery goes into the ‘charging’ state 254. In this state the battery of the external battery device is charged from a mains power adapter or mains charger. Preferably, an LED indicator indicates charging, such as by the source of one or more LEDs in a predetermined pattern. When the mains adapter is switched off 278 the charging stops and the device switches off again.

It is alternatively contemplated that from the turned on state 252 the device transitions to the ‘discharged’ state 253 when it happens that the plug 10 of the output cable 16 according to a preferred embodiment of the external battery is plugged into the charging port of the bicycle. In this switched-on state, the external battery is plugged into the bicycle, nor a mains charger is plugged into the external battery. This makes this switched-on state a kind of resting state.

From the “on” state, the external battery changes 265 from the “discharged” state 253 to the “on” state 252 when this plug 10 of the output cable is removed from the bicycle 266. In this “discharged” state, the secondary battery is ready for supplying power to the bicycle, for example by charging the internal battery from the battery or by supplying power directly, at least not via the internal battery to the motor of the bicycle, thereby contributing to the power flow used by the bicycle's motor, optionally in addition to a parallel power flow from the bicycle's internal battery to this motor. From this state of discharging it is furthermore possible to switch 276 to the state of ‘resetting’ by keeping the button pressed by the user for longer than 5 seconds.

Alternatively, it is possible to change directly from the shutdown state 251 to the “discharged” state 253 by inserting the plug 10 of the external battery output cable 16 into the charging port of the bicycle and -press the button briefly. Conversely, the device switches from the discharged state 262 to the ‘disengaged’ state in three preferred cases, either when the charge state of the internal battery of the bicycle is greater than a predetermined value such as 97%, or when the charge power of the external battery is less than a predetermined value such as one percent, or when the plug 10 is taken out of the charge port of the bicycle.

From the ‘charging’ state, it is possible to transition into the ‘discharged’ state by inserting 268 the plug 10 of the external battery output cable 16 into the charging port of the bicycle. This creates a state where the battery of the external battery device is charged while power is transferred from the battery of the external battery device to the charging connector of the bicycle. This enables the bicycle to charge the internal battery. In this state, preferably no power is transferred to the bicycle motor because the external battery is plugged into a mains adapter. By performing step 267 of disconnecting the plug 10 of the output cable 16 of the external battery from the charging port of the bicycle, the “discharged” state of the external battery is terminated and proceeds the same in the state “charging”.

It is further provided that when from the ‘charging’ state 254 the plug 10 of the output cable of the external battery is plugged 271 into the bicycle, the external battery changes into the ‘bypass’ state 255, the charging current from the mains adapter is passed on to the charging port of the bicycle so that the internal battery of the bicycle is charged with the maximum charging current. If the charge level of the internal battery of the bicycle limits this charging current to the internal battery, the remainder is advantageously used for charging the external battery. In case of removal 272 of this plug 10, the state ‘bypass’ is left and the state ‘charging’ remains. Alternatively, it is shown that if during the bypass state 255 the mains adapter is removed 270 from the external battery, the external battery will go into the “discharged” state because it also exits the “charging” state. If the mains adapter is plugged in again 269, the combination of states ‘by-pass’ and ‘charging’ is switched to again.

There are several options for resetting the external battery. In addition to said holding 276 of the button when the external battery is in the “discharged” state 253, it is possible to pass from the “off” state 251 to the reset state by holding 273 of the button during the predetermined length of time. Also from the “bypass” state there is the possibility of holding the button 274 leading to reset. Also from the ‘charging’ state 254 there is the possibility of holding 275 the button leading to reset. Also, when the external battery device is in a fault condition, indicated by the indication with the red LEDs, there is the possibility of resetting 250″ by holding the button. From the ‘reset’ state 256, the external battery device changes to the ‘on’ state 252. Then the external battery switches off 264.

A format of a message transmitted between the secondary bicycle drive battery and the bicycle is for byte 0-7 according to a preferred embodiment as follows:

| CMD | 0 | 1 | 2 | 3 | 4 | 5 | 6 | 7 |
|---|---|---|---|---|---|---|---|---|
| Serial number | 0 | S/N_1st | S/N_ | S/N_ | S/N_ | S/N_ | CRC_L | CRC_H |
| Firmware Version | 1 | AA | BB | CC | CRC_L | CRC_H | | |
| SOC | 2 | DD | CRC_L | CRC_H | | | | |

The serial number must relate to the battery serial number of the secondary battery. The data type is preferably as key encoding. The encoding line is 0˜9, a˜Z, except O. The message is sent when power is turned on, such as plugging in an AC adapter or actuating the power button. An example of the encoding: ADZ50 is encoded as alpha, delta, zeta, five, zero. The firmware version refers to a modbus battery firmware version and/or coding style. A data type, a coding rule applies here and that the message is sent when the power is switched on, such as when a mains adapter is plugged in or the on-off button is actuated. SOC means battery charge in percentage. Here, the data type is a byte, the encoding number is a byte, the transmit rule is when turned on, or every 3 minutes in load mode. Example: 87% is coded as 0x57. A CRC is performed at the communication.

The encryption is performed as follows. A start bit is encoded as HH, a stop bit is encoded as LL, a logic 0 is encoded as LH, a logic one is encoded as HL. All bytes or the whole message is sent together. Speed is preferably set to 600 bits per second.

### Definitions

A drive power source according to this document is a battery that supplies power to the drive motor for propulsion of the bicycle. In contrast to this, it is provided that the bicycle additionally comprises a generally much smaller battery for operating an on-board computer, communication means such as a Bluetooth module and/or a communication module for mobile networks such as mobile telephone networks of the types 2G-6G or computer networks as per the Wifi standard. This indicates that the primary battery and the secondary battery according to the description of the present invention should be viewed separately from any further battery or on-board computer battery. The on-board computer and/or communication means of the bicycle are therefore available for respective functions after the position of the drive battery.

The secondary output current according to this document refers to the output current of the secondary battery, such as for the charging connector of the bicycle, as intended for the primary battery. With this, the secondary output current forms the primary charging current of the primary battery. The secondary charging current in this document refers to the charging current of the secondary battery through the secondary charging connector from a mains adapter.

Any numerical values of a parameter used in the examples according to the preferred embodiments are purely exemplary and depending on an implementation are adjustable, for example, to a value of at least one order of magnitude smaller or one order of magnitude larger.

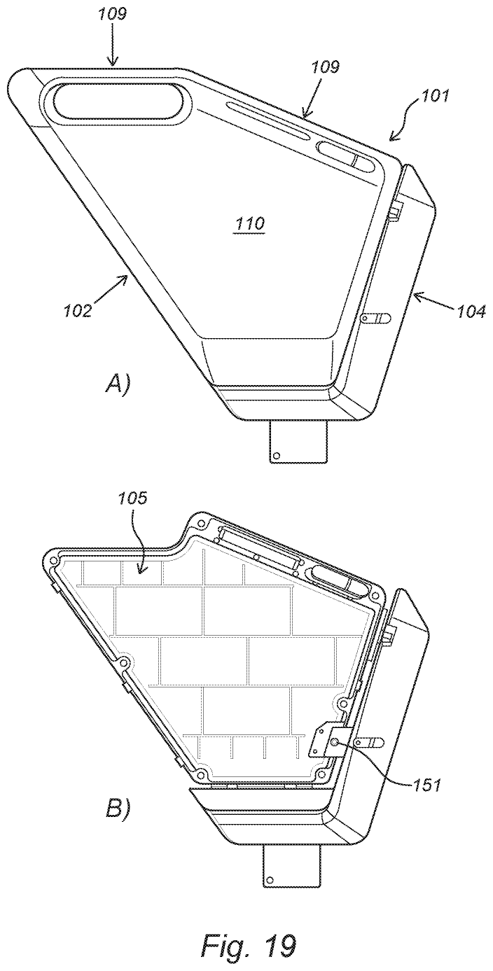

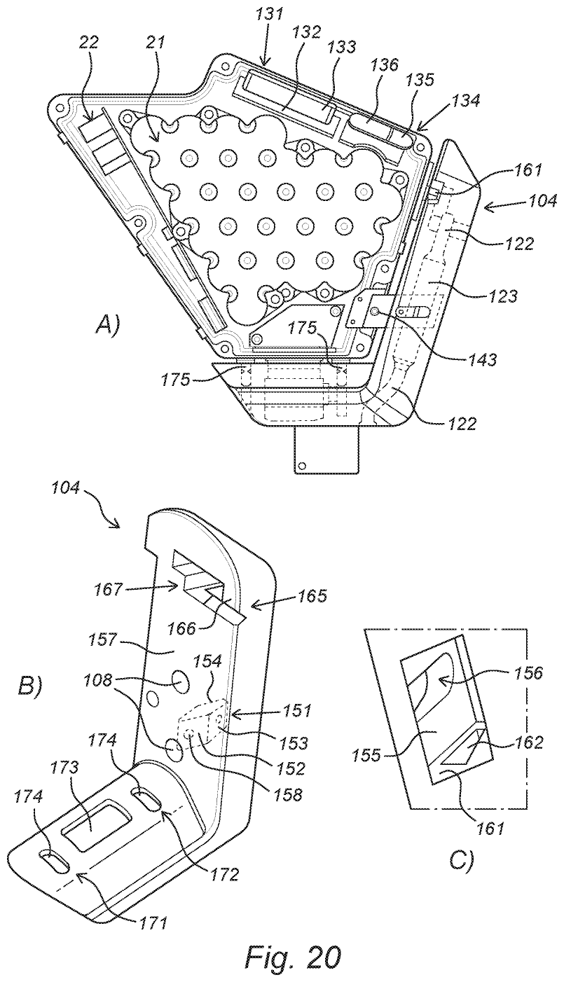

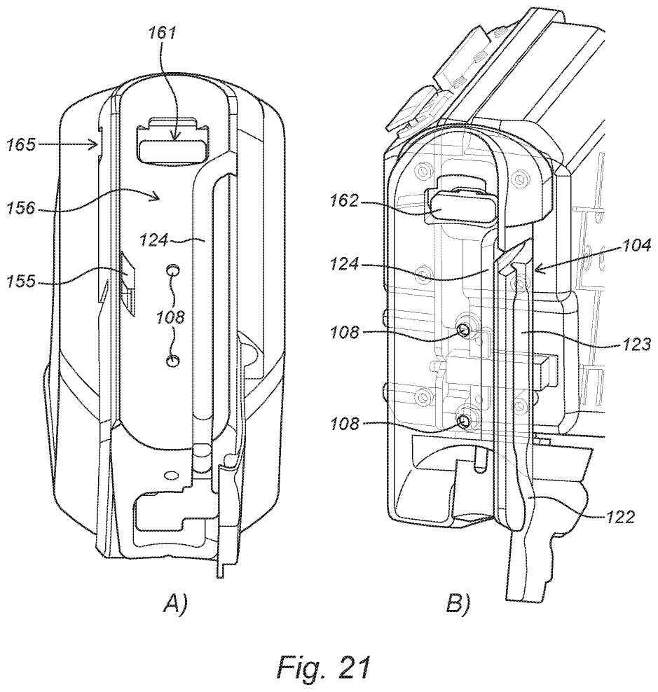

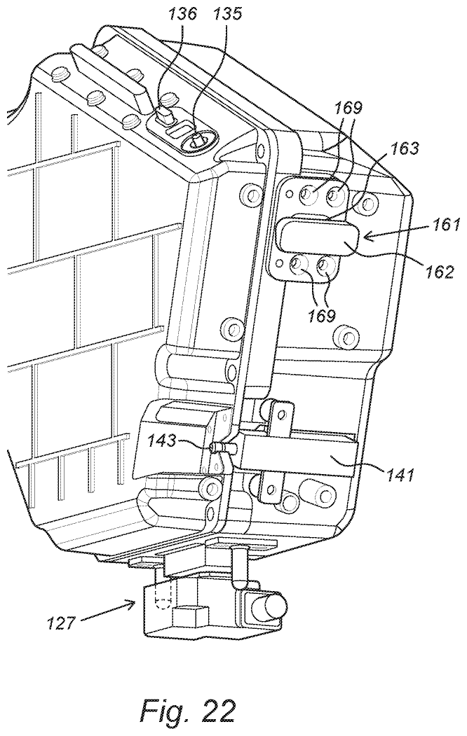

FIGS. 19-23 show a further preferred embodiment of a secondary bicycle drive battery 101 or bicycle drive battery assembly 101 of a battery assembly 102 with a docking station 104. The battery assembly includes a base housing 105 within which the battery with the electronics is housed and an enveloping housing 109, 110 including a handle 109 for handling the housing. The docking station 104 is permanently mountable to the frame of the bicycle. To this end, it includes two openings 108 for a connection, such as a screw connection, to the seat tube of the bicycle. To this end, the saddle tube is locally provided with an opening for the passage of a cable for the secondary battery and for placing a suitable fastening means for the docking station 104 in the opening.

The secondary bicycle drive battery according to this preferred embodiment is charged by means of a power supply which it shares with the primary battery. The secondary bicycle drive battery according to these preferred embodiments is further provided with a capability of supplying a drive current to the drive motor in a similar manner to the primary battery and, in contrast to the foregoing preferred embodiment, is hereby not limited to a charging current may be taken up through the charge port of the bicycle.

A charge current cable extends from the seat tube from the opening of the seat tube through the docking station to a connector assembly 127 of the docking station through a channel 122 beginning at the bottom of the docking station. The channel extends through a space 123 for holding a connector up and then down through a portion 124 of the channel so that the cable reaches the connector assembly 127 on the underside of the docking station. It is of advantage here that a cable extending from the inside of the frame ends with a connector that can be arranged in the connector space 123 of the docking station 104. A further cable 126 extends from this connector to the connector assembly 127 of the docking station for connecting to a battery connector.

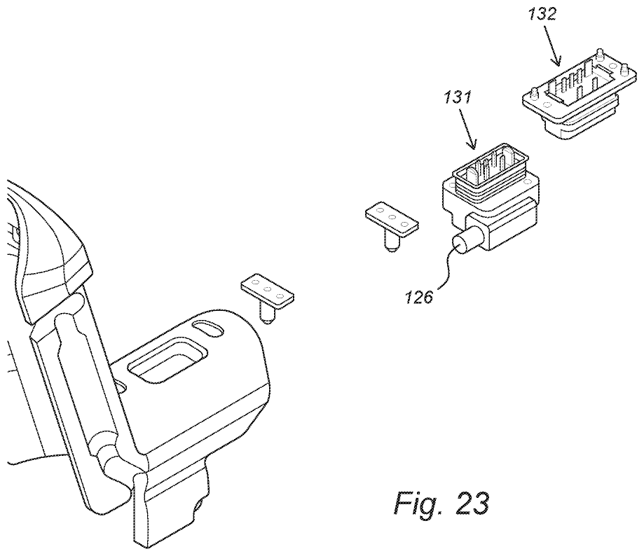

An advantage of this is that in the event of damage to the connector of the docking station, it can easily be replaced by replacing the further cable from the connector space 123. In the cut-away view of FIG. 23, the further cable 126 with the docking station connector 131 is shown. Furthermore, the battery connector 132 is shown from the battery side thereof. This connector serves for communication between the external battery and the bicycle as well as for charging and discharging the external battery. When the external battery is discharged, either current is supplied to the drive motor of the bicycle or the internal battery is charged. This preferred embodiment therefore has no current connection to the charging connector of the bicycle.

Within the base housing 105 are the drive electronics 22, such as including the BMS for charging and discharging the battery cells of the battery cell assembly 21. At the top of the base housing is a display module 131 including a printed circuit board 132 for controlling the module with a number of LEDs arranged thereon, the light of which is passed on to the user via a light guide 133. Also at this top side is a connector module 134 comprising an operating button 135 and a USB port 136 for, for instance, communication with the electronics in the secondary battery.

In this embodiment, the docking station 104 serves the purpose of positioning the housing at the bicycle. The docking station 104 is arranged with a round supporting surface 156 against the seat tube of the frame. At the other side of the docking station there is a substantially surface on support surface 157 for the battery housing. Located in this surface, is a guide channel 165 comprising a substantially horizontal part 166 and a substantially vertical part 167. The housing of the battery has a guide element 161 which can be attached to the housing by means of screw holes 169. A blocking element 162 blocks the guiding element 161 in the guide channel. Upon placement of the battery at the docking station, the blocking element 162 is slid sideways into the guide channel 165, specifically into the horizontal portion 166 thereof. Next, the guide member is lowered into the vertical portion 167 of the guide channel.

This final act of lowering the housing upon placement in the docking station is possible when the pins 175, serving to protect the connector, are brought through insertion slots 171, 172 to insertion holes 174 for the pins 175.

By the combination of inserting the guide element 161 into the vertical part 167 of the guide channel and simultaneously placing the pins 175 above the insertion openings 174, it is advantageously realized that the housing can be moved downwards, which inserts the battery connector 132 into the docking station connector 131. In this way the housing is placed in the same movement and the connection to the respective connector is made while the connector remains protected. The housing with the connector can be moved downwards, wherein it will thereby be upright.

For the purpose of preventing unauthorized removal of the battery from the docking station, a bolt 151 is provided. This bolt 151 is arranged in channel 155 of the docking station. In the bottom of the channel 155 of the docking station there is an opening 162 with a spring therein for the purpose of urging the bolt into the closed position under bias. A slot 156 serves for passing an operating element, such as a knob for the bolt, to the outside of the docking station. This allows the bolt to be operated against the bias. Preferably, the bolt is held under bias towards the locking state of the bolt. Depending on the desired implementation, this can also be applied in reverse.

The bolt is held in the locked condition by an opening 158 through which a pin 143 of the solenoid 141 is insertable. The solenoid can be operated by the bicycle's central on-board computer via a data connection via the connector. The solenoid is mounted on the outside of the base housing and on the inside of the cladding housing. The operation of the solenoid is alternatively possible by means of a pin code which may be entered by means of the operating button 135, but preferably by means of an application on a mobile device of the rider of the bicycle via the central on-board computer. In a further alternative manner, the operation of the solenoid via the on-board computer may be realized by means of an operating button on the handlebar of the bicycle. For this manner of operation, data communication is provided between the control unit in the battery and the central on-board computer, using the connector of the docking station.

### Clauses.

1. A secondary bicycle drive battery or bicycle drive battery assembly for a bicycle as a secondary, preferably external, energy source in addition to a primary bicycle drive battery as the primary, preferably internal, driving energy source of the bicycle for thereby driving a driving motor, the secondary bicycle drive battery including:
   a housing,
   a predetermined number of battery cells,
   fasteners connected or connectable to the housing for attachment of the housing to the bicycle, such as a frame thereof,
2. Battery or battery assembly according to clause 1, comprising a measure according to one or more of the claims 10-16.
3. Battery or battery assembly according to any one of the preceding clauses comprising a connector assembly for providing a releasable electrical connection and/or data connection between the battery or battery assembly, the connector assembly comprising a bicycle side connector and a battery side connector includes. Preferably, the bicycle side connector is located on the docking assembly or docking station. More preferably, the battery side connector is located on the housing or base housing, cladding housing or mounting housing thereof.
4. Battery or battery assembly according to one or more of the foregoing clauses, wherein the fastening means comprise guide means for guiding the housing from a loose or free state to an attached state. Preferably, the guide means comprise a guide channel for cooperation with a guide element which is guided through the guide channel. More preferably, the guide channel comprises a part with an insertion direction and a part with an attachment direction. The guide channel is herein preferably an open channel for guiding the guide element. It is hereby preferably provided that the guide element is introduced into the part with the insertion direction up to a preferably end of this part with the insertion direction, after which the direction of the guide element is further preferably changed to the direction of the part with the insertion direction. Preferably, moving in that direction brings the battery into the attached condition. More preferably, moving in that direction of attachment brings the battery into a connected state wherein the bicycle side connector is connected to the battery side connector.
5. Battery or battery assembly according to one or more of the foregoing clauses, wherein the guide element is provided with blocking means for keeping it enclosed in the channel. Preferably, the blocking means may be inserted into the guide channel at the beginning of the guide channel.
6. Battery or battery assembly according to one or more of the foregoing clauses, comprising a lock assembly securing the housing to the bicycle, the mounting means and/or the docking station.
7. Battery or battery assembly according to clause 6 comprising a locking member, preferably embodied as an electrically actuable locking member, such as by means of an electric motor or solenoid, providing a locking. Preferably, this provides a locking between an element of the housing and an element of the fastening means.
8. Battery or battery assembly according to any one of the preceding clauses comprising a bolt for locking the housing against removal from the coupling assembly. Such a bolt is designed for absorbing tensile forces which are deployed when the housing is removed undesirably. Such a bolt here provides for instance the advantage that placement of the housing is relatively simple while this blocking is realized.
9. Battery or battery assembly according to the foregoing clause 8 wherein the bolt includes a receiving opening for the locking member. Advantageously, the locking member hereby provides a locking of the bolt. This advantageously realizes that the locking element can be of a relatively light or compact design, because it needs to withstand relatively little tensile force, since the bolt is designed to absorb these tensile forces.
10. Battery or battery assembly according to one or more of the foregoing clauses wherein the bolt is arranged on the coupling assembly, preferably wherein the bolt is provided with biasing means for biasing towards a blocking position, further preferably wherein the bolt is provided with actuating means for actuating the bolt to a releasing position.
11. Battery or battery assembly according to one or more of the foregoing clauses, wherein the bolt is arranged on the housing, preferably wherein the bolt is provided with biasing means for biasing towards a blocking position, further preferably wherein the bolt is provided with actuating means for actuating the bolt to a releasing position. Alternatively, it is of course provided that in these preferred embodiments the bolt may be provided with biasing means for biasing the bolt to the releasing position in combination with actuating means for actuating the bolt to the blocking position.
12. Battery or battery assembly according to one or more of the foregoing clauses, wherein the bolt is designed as a latch bolt with a sloping side and wherein the bolt has a blocking effect with respect to the housing in a direction which is a different direction of insertion of the housing with respect to the oblique side thereof, such as substantially perpendicular thereto.
13. Battery or battery assembly according to one or more of the foregoing clauses, wherein the blocking action relative to the housing acts in the direction of attachment of the respective part of the guide channel. It is hereby advantageously realized that the bolt cooperated with the channel and the guide element for blocking the housing relative to the bicycle, the fastening means and/or the coupling assembly. In a preferred embodiment, therefore, the guide element is arranged in the guide channel so that it can only move in the guide direction, being blocked by the bolt.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1-23. (canceled)

24. A secondary bicycle drive battery for a bicycle as a secondary, preferably external, energy source in addition to a primary bicycle drive battery as a primary, preferably internal, drive energy source of the bicycle, for there with driving of a drive motor, the secondary bicycle drive battery comprising:
a housing,
fastening means that are connected or connectable with the housing for fastening of the housing to the bicycle, such as a frame thereof,
a predetermined number of battery cells,
a control unit, such as a BMS, such as for controlling of charging and discharging of the battery cells,
a voltage regulation circuit, such as a voltage stabilization circuit or a boost circuit, for controlling of a voltage of a secondary output current to a predetermined value for providing of an input current, such as via a charge connector, for the bicycle,
a charge current connection, such as comprising a current output connector or a charge cable, for providing of the secondary output current to the bicycle, such as to the charge connector thereof, and
a communication unit for communication of a signal for the purpose of communicating of status information with regards to the secondary battery to the bicycle, such as to.

25. The secondary bicycle drive battery according to claim 24, wherein the communication unit is arranged for communication with the bicycle via the charge current connection.

26. The secondary bicycle drive battery according to claim 25, wherein the communication unit is arranged for communicating by means of the signal over the charge current, such as by varying a parameter of the charge current, such as voltage or current, such as by means of a series of charge current pulses or charge current interruptions and/or wherein the communication unit is arranged to communicate by means of the signal during a switch-on sequence or starting during the switch-on sequence for a predetermined time.

27. The secondary bicycle drive battery according to claim 25, wherein the communication unit is arranged to communicate by means of a signal spread over a period that the external battery is switched on and coupled to the bicycle via the charge current connection.

28. The secondary bicycle drive battery according to claim 24, wherein the communication unit is adapted to communicate by means of the signal, such as by means of modulation means, preferably comprising means for modulating a phase of the signal and wherein the communication unit comprises means for phase shift modulation or binary phase shift modulation, further preferably using a self-clocking or self-synchronizing signal, further preferably embodied as Manchester code.

29. The secondary bicycle drive battery according to claim 24, wherein the communication unit is arranged for wireless communication, such as a short range wireless channel for communication in a range up to 10, 100 or 200 m, such as using a module for Bluetooth or Wifi.

30. The secondary bicycle drive battery according to claim 24, comprising a current level controller for controlling and/or measuring the current intensity, preferably at a predetermined current level, of the secondary output current and/or wherein the fastening means are arranged for arranging the secondary bicycle drive battery at the location of an internal angle between two frame tubes, such as between two frame tubes of the frame, such as a diamond frame, preferably between the seat tube and the down tube.

31. The secondary bicycle drive battery as claimed in claim 24, wherein the fastening means comprise a lock assembly for securing the secondary bicycle drive battery to the bicycle, preferably by means of a lock.

32. The secondary bicycle drive battery according to claim 24, wherein the fastening means comprise a docking assembly for mounting it to the frame of the bicycle, such as at the internal corner between two frame tubes, preferably wherein the lock is arranged at the docking assembly.

33. The secondary bicycle drive battery according to claim 31, comprising a lock engaging member, such as a bolt receiving opening, locking pin receiving opening or eye, for engagement with the lock, such as with a bolt or locking pin thereof.

34. The secondary bicycle drive battery according to claim 24, wherein the fastening means comprises at least one support member for supporting against a frame tube of the bicycle, preferably wherein such support member comprises a plastic material, such as a resilient plastic or a foam material.

35. The secondary bicycle drive battery according to claim 24 comprising an operating assembly for user operation, such as for switching on, switching off, changing setting, or resetting.

36. The secondary bicycle drive battery according to claim 24, wherein the housing comprises a basic housing for holding electrical and/or electronic components, preferably further comprising a cladding housing and/or mounting housing for cladding and/or mounting the basic housing to the bicycle.

37. A method of controlling a secondary bicycle drive battery for a bicycle as a secondary, preferably external, energy source in addition to a primary bicycle drive battery as the primary, preferably internal, driving energy source of the bicycle for driving a driving motor therewith, the method comprising—the steps for:
sending a communication message from the secondary bicycle drive battery to the bicycle, such as an on-board computer, BMS, communication module thereof or primary bicycle drive battery thereof, and
providing a charge voltage for a charge current for the primary bicycle drive battery.

38. The method of claim 37 further comprising one or more steps of:
allowing the charge current to be taken up by the bicycle, its BMS or primary bicycle drive battery, and/or
monitoring the magnitude of the charge current continuously or at predetermined intervals, and/or
switching off the charge current and/or the secondary bicycle drive battery in the event of a determination that the charge current is below a threshold value.

39. A method of controlling a bicycle having a primary bicycle drive battery and a secondary bicycle drive battery for drawing power from the combination of primary driving battery and secondary bicycle drive battery as a secondary energy source in addition to drawing power from a primary bicycle drive battery, the method comprising steps for:
detecting connecting of the secondary bicycle drive battery to a charge port of the bicycle,
receiving a message including a charging status and/or identification of the secondary bicycle drive battery, and
taking up power from the secondary bicycle drive battery for the primary bicycle drive battery and/or a drive motor.

40. The method of claim 37, wherein the communication between the secondary bicycle drive battery and the primary bicycle drive battery is performed over a charge current connection, such as comprising a power output connector or a charge cable from the secondary bicycle drive battery to the bicycle, such as via the charge connector thereof.

41. The method according to claim 37, wherein the communication between the secondary bicycle drive battery and the primary bicycle drive battery is performed by means of a signal over the charge current, such as by varying a parameter of the charge current, such as voltage or current, such as by means of a series of charge current pulses or charge current interruptions.

42. The method according to claim 37, wherein the communication between the secondary bicycle drive battery and the primary bicycle drive battery is performed by means of a wireless communication protocol, such as a short range wireless channel for communication in a range of up to 10, 100 or 200 m, such as using a module for Bluetooth or Wifi.

43. The method according to claim 37, comprising steps of blocking or switching off of a charge current between the secondary bicycle drive battery and the primary bicycle drive battery in case of incorrect authentication of the secondary bicycle drive battery.
